(19) United States
(12) Patent Application Publication
(10) Pub. No.: US 2018/0010527 A1
(43) Pub. Date: Jan. 11, 2018

(54) SYSTEM OF OPERATING A GAS TURBINE ENGINE

(71) Applicant: ROLLS-ROYCE plc, London (GB)

(72) Inventor: Arthur L. ROWE, Derby (GB)

(73) Assignee: ROLLS-ROYCE plc, London (GB)

(21) Appl. No.: 15/637,400

(22) Filed: Jun. 29, 2017

(30) Foreign Application Priority Data
Jul. 11, 2016 (GB) 1612021.4

(51) Int. Cl. F02C 9/28; B64D 33/02; F02C 9/24; F02C 7/057; B64D 15/20; F02C 7/047; F01D 25/02

(52) U.S. Cl. CPC F02C 9/28; F02C 7/057; B64D 33/02; B64D 15/20; F02C 9/24; F01D 25/02; B64D 2033/0233; F02C 7/047; F05D 2220/32; F05D 2270/301; F05D 2270/303; F05D 2270/44

(57) ABSTRACT

A system for operating a gas turbine engine to mitigate the risk of ice formation within the engine, the system including a controller arranged to control at least one operational parameter of the engine such that the engine operates in a safe zone; and, a processor configured to function as a determining module to make a comparison between values and determine whether the engine is operating within a safe zone based on at least a core pressure parameter relating to the pressure within the engine and a core temperature parameter relating to the temperature within the engine, wherein the safe zone is defined by the product (multiplied) of the core pressure parameter and core temperature parameter being above a safe threshold.

This disclosure relates to a system and method for operating a gas turbine engine of an aircraft to mitigate the risk of ice formation within the gas turbine engine.

There is a risk during cruise or descent of an aircraft of ice formation and the build-up of ice within the engine of the aircraft. This presents a danger to the engine as any ice build-up may shed and cause engine instability or damage. Additionally, ice build-up on fan or compressor blades may result in deflection of the blades and cause further damage to the engine during flight.

In a previously considered arrangement the engine idle speed of the engine is increased during descent conditions in order to reduce the risk of ice formation. However, this results in a significant increase in fuel consumption during descent and it cannot be guaranteed to eliminate the formation of ice.

It is therefore desirable to provide an improved method and system for operating a gas turbine engine to mitigate the risk of ice formation.

According to a first aspect of the disclosure, there is provided a system for operating a gas turbine engine to mitigate the risk of ice formation within the engine, the system comprising:
a controller configured to control at least one operational parameter of the engine such that the engine operates in a safe zone; and,
a processor configured to function as a determining module to make a comparison between values and determine whether the engine is operating within the safe zone based on at least a core pressure parameter relating to the pressure within the engine and a core temperature parameter relating to the temperature within the engine, wherein the safe zone is defined by the product (multiplied) of the core pressure parameter and core temperature parameter being above a safe threshold. The safe zone may be operating conditions of the engine which are known to be reliably safe from ice formation. The term “core” is used to refer to a temperature/pressure within the gas turbine engine, such as in the region of the inlet to the high pressure compressor.

The core temperature parameter may be on a scale that has zero at freezing point (for example degrees centigrade). When the pressure is measured in psia and the temperature is measured in degrees centigrade, the safe threshold may be 160 psia° C. Thus, when the product of the core pressure parameter and core temperature parameter is compared to the safe threshold, if the product of the core pressure parameter and the core temperature parameter is more than the safe threshold e.g. 160, it is determined that the engine is in the safe zone.

The core pressure parameter may relate to the static pressure within the engine.

The core pressure parameter may relate to the static pressure within the engine and the core temperature parameter may relate to the stagnation temperature within the engine.

The core pressure parameter may be generated using a pressure sensor or alternatively may be calculated based on at least an inlet pressure parameter relating to the pressure in the region of the inlet of the engine, and/or based on the rotational speed of one or more of the fan and the intermediate pressure compressor. The inlet pressure parameter may be generated using a pressure sensor located in the region of the inlet of the engine.

The core temperature parameter may be calculated based on at least the core pressure parameter.

The core pressure parameter and the core temperature parameter may relate to the pressure and temperature respectively in the region of the inlet to the high pressure compressor of an engine. This may be an area at high risk of ice formation within the engine.

The system may further determine that there is a risk of icing and in response thereto, control at least one operational parameter of the engine such that the engine operates in the safe zone. The system may determine that there is a risk of icing based on at least it being determined that the aircraft is in descent and/or based on at least it being determined that the ambient temperature is within a predefined range. The predefined range may be between 6 and 20 degrees centigrade above a temperature defined by the International Standard Atmosphere. In this predefined temperature range, the risk of icing is significantly higher than outside this range. The system may also determine that there is a risk of icing based on at least it being determined that a measured temperature parameter relating to a temperature within the engine is below a threshold. This threshold may be based on the expected temperature within the engine, such that, if the measured temperature is below the threshold e.g. the expected temperature, the system may determine that there is a risk of icing. Alternatively, the threshold may be about 5 degrees centigrade or about 10 degrees or more centigrade below the expected temperature. The system determining that there is a risk of icing may comprise any of the above examples in any combination. The expected temperature may be calculated by the system based on an inlet pressure parameter, an inlet temperature parameter and the core pressure parameter.

The system controlling at least one operational parameter may comprise controlling the idle speed of the engine. Therefore, if it is determined that the engine is not operating within the safe zone, the idle speed may be increased until the engine is operating within the safe zone. Alternatively or additionally, controlling at least one operational parameter may comprise controlling the bleed from the compressor, the variable inlet guide vanes and/or the variable stator vanes. The above operational parameters may be controlled by the system alone or in any combination to ensure that the engine is operating within the safe zone.

According to a second aspect of the disclosure, there is provided a method of operating a gas turbine engine of an aircraft to mitigate the risk of ice formation within the engine, the method comprising controlling at least one operational parameter of the engine such that the engine operates in a safe zone, wherein it is determined that the engine is operating within a safe zone based on at least a core pressure parameter relating to the pressure within the engine and a core temperature parameter relating to the temperature within the engine, wherein the safe zone is defined by the product (multiplied) of the core pressure parameter and core temperature parameter being above a safe threshold.

The safe zone may be operating conditions of the engine which are known to be reliably safe from ice formation. The term “core” is used to refer to a temperature/pressure within the gas turbine engine, such as in the region of the inlet to the high pressure compressor.

The core temperature parameter may be on a scale that has zero at freezing point (for example degrees centigrade). When the pressure is measured in psia and the temperature is measured in degrees centigrade, the safe threshold may be 160 psia° C. Thus, when the product of the core pressure parameter and core temperature parameter is compared to the safe threshold, if the product of the core pressure parameter and the core temperature parameter is more than the safe threshold e.g. 160, it is determined that the engine is in the safe zone.

The core pressure parameter may relate to the static pressure within the engine and the core temperature parameter may relate to the stagnation temperature within the engine.

The core pressure parameter may be generated using a pressure sensor or alternatively may be calculated based on at least an inlet pressure parameter relating to the pressure in the region of the inlet of the engine, and/or based on the rotational speed of one or more of the fan and the intermediate pressure compressor. The inlet pressure parameter may be generated using a pressure sensor located in the region of the inlet of the engine.

The core temperature parameter may be calculated based on at least the core pressure parameter.

The core pressure parameter and the core temperature parameter may relate to the pressure and temperature respectively in the region of the inlet to the high pressure compressor of an engine. This may be an area at high risk of ice formation within the engine.

The method may further comprise determining that there is a risk of icing and in response thereto, controlling at least one operational parameter of the engine such that the engine operates in the safe zone. It may be determined that there is a risk of icing based on at least it being determined that the aircraft is in descent and/or based on at least it being determined that the ambient temperature is within a predefined range. The predefined range may be between 6 and 20 degrees centigrade above a temperature defined by the International Standard Atmosphere. In this predefined temperature range, the risk of icing is significantly higher than outside this range. It may also be determined that there is a risk of icing based on at least it being determined that a measured temperature parameter relating to a temperature within the engine is below a threshold. This threshold may be based on the expected temperature within the engine, such that, if the measured temperature is below the threshold e.g. the expected temperature, it may be determined that there is a risk of icing. Alternatively, the threshold may be about 5 degrees centigrade or about 10 degrees or more centigrade below the expected temperature. Determining that there is a risk of icing may comprise any of the above examples in any combination. The expected temperature may be calculated based on an inlet pressure parameter, an inlet temperature parameter and the core pressure parameter.

Controlling at least one operational parameter may comprise controlling the idle speed of the engine. Therefore, if it is determined that the engine is not operating within the safe zone, the idle speed may be increased until the engine is operating within the safe zone. Alternatively or additionally, controlling at least one operational parameter may comprise controlling the bleed from the compressor, the variable inlet guide vanes and/or the variable stator vanes. The above operational parameters may be controlled alone or in any combination to ensure that the engine is operating within the safe zone.

According to another aspect, there is provided a system for operating a gas turbine engine to mitigate the risk of ice formation within the engine comprising a controller arranged to control at least one operational parameter of the engine such that the engine operates in a safe zone, and a safe zone determining module arranged to determine whether the engine is operating within the safe zone based on at least a core pressure parameter relating to the pressure within the engine and a core temperature parameter relating to the temperature within the engine.

The core pressure parameter may relate to the static pressure within the engine and the core temperature parameter may relate to the stagnation temperature within the engine.

The safe zone determining module may be arranged to determine that the engine is operating within the safe zone when the product of the core pressure parameter and the core temperature parameter is above a safe threshold. The safe threshold may be 160 when the pressure is in psia and the temperature is in degrees centigrade.

The system may further comprise a calculation module arranged to calculate the core temperature parameter based on at least the core pressure parameter and/or to calculate the core pressure parameter based on at least an inlet pressure parameter relating to the pressure in the region of the inlet of the engine.

The system may further comprise an icing risk determining module arranged to determine whether there is a risk of icing.

The icing risk determining module may determine that there is a risk of icing when the aircraft is in descent and/or when the ambient temperature is within a predefined range. The icing risk determining module may also determine that there is a risk of icing when a measured temperature parameter within the engine is below a threshold. This threshold may be based on an expected temperature within the engine, such that, if the measured temperature is below the threshold e.g. the expected temperature, it may be determined that there is a risk of icing. Alternatively, the threshold may be about 5 degrees centigrade or about 10 degrees centigrade or more below the expected temperature. Determining the risk of icing may comprise any of the above examples in any combination.

The calculation module may be further arranged to determine the expected temperature based on an inlet pressure parameter, an inlet temperature parameter and the core pressure parameter.

The controller may be arranged to control the idle speed, the bleed from the compressor, the variable inlet guide vanes and/or the variable stator vanes.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

Various arrangements will now be described, by way of example, with reference to the accompanying drawings, in which:

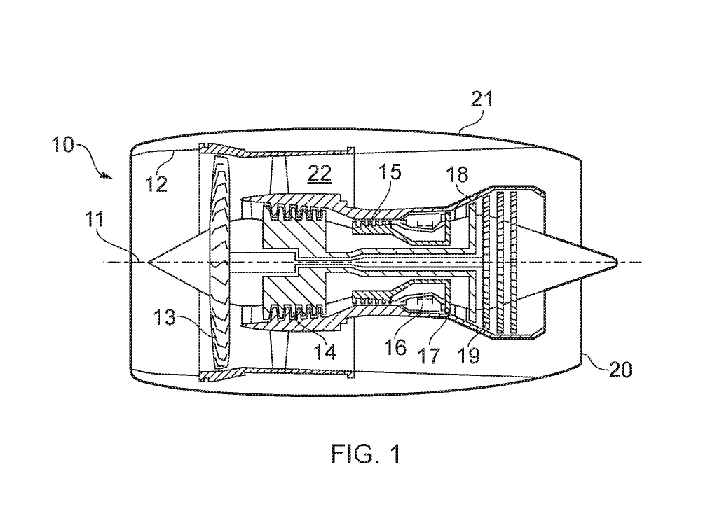

FIG. 1 schematically shows a cross-section of a turbofan gas turbine engine; and

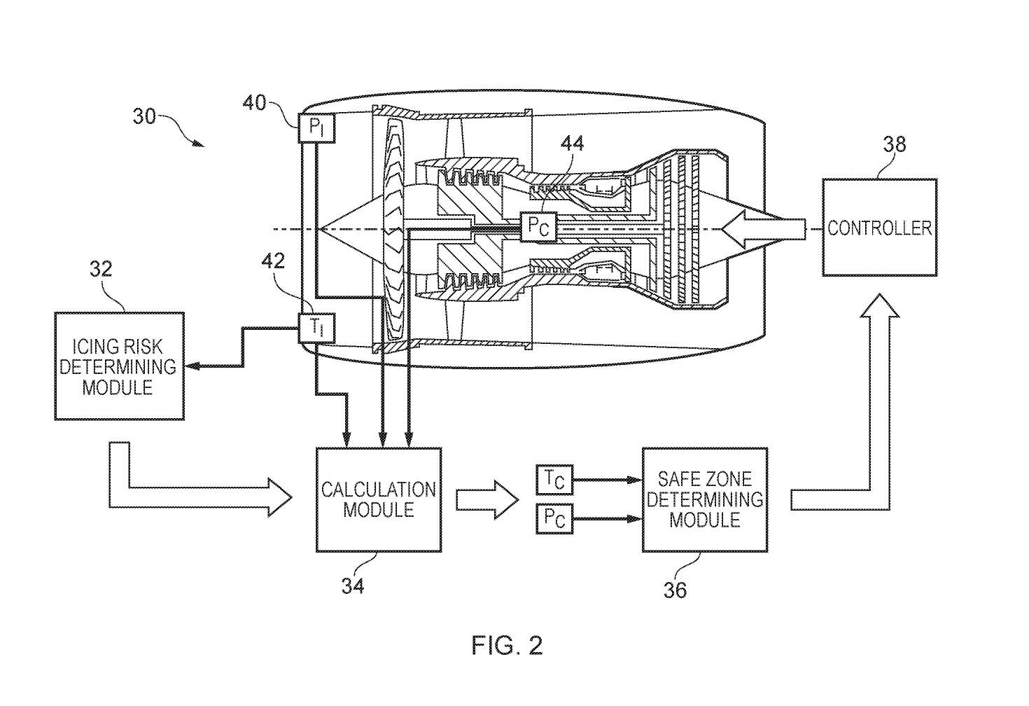

FIG. 2 schematically shows the system for the method of operating the gas turbine engine according to a first arrangement.

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

During operation, air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

During use, it is possible for ice to form within the engine. The conditions for ice formation are particularly likely to occur in areas of moderate pressure, such as the inlet to the high pressure compressor 15. This is due to the fact that compression of air reduces the relative humidity of the air. This means that more water may be evaporated into the air before it becomes saturated, and therefore results in a lower wet bulb temperature relative to the dry bulb temperature. This may result in the condition where the wet bulb temperature is below freezing whilst the dry bulb temperature is above freezing.

As will be described in detail below, in order to mitigate the risk of ice formation within the engine 10, the gas turbine engine 10 is provided with a control system for controlling the gas turbine engine 10.

FIG. 2 shows a control system 30 for operating the gas turbine engine 10 to mitigate the risk of ice formation within the engine 10. The control system 30 may accelerate or decelerate the engine by manipulating one or more of fuel flow, compressor settings or operating conditions of the gas turbine engine 10. The control system 30 comprises an icing risk determining module 32, a calculation module 34, a safe zone determining module 36 and a controller 38, also known as an Engine Electronic Controller (EEC). The EEC may read data from one or more of sensors, avionic systems or pilot input controls to calculate required positions of actuators, valves or pumps. The EEC may manipulate their settings thereafter to achieve a given operating condition. Such manipulation may vary according to a feedback signal representing a current operating condition.

In some examples, the safe zone determining module 36 refers to a device or apparatus where one or more features are included at a later time and, possibly, by another manufacturer or by an end user. The safe zone determining module 36 may comprise any suitable circuitry to cause performance of the steps described herein. The safe zone determining module 36 may comprise: control circuitry; and/or processor circuitry; and/or at least one application specific integrated circuit (ASIC); and/or at least one field programmable gate array (FPGA); and/or single or multi-processor architectures; and/or sequential/parallel architectures; and/or at least one programmable logic controllers (PLCs); and/or at least one microprocessor; and/or at least one microcontroller; and/or a central processing unit (CPU); and/or a graphics processing unit (GPU), to perform the steps described herein.

In various examples, the safe zone determining module 36 may comprise at least one processor. In some examples, the safe zone determining module 36 may be comprised of at least one processor. Additionally or alternatively, the safe zone determining module 36 may comprise at least one memory (not shown). The memory may store a computer program comprising computer readable instructions that, when read by the processor, causes performance of the steps described herein. The computer program may be software or firmware, or may be a combination of software and firmware.

It should be appreciated that the steps described herein may be performed ‘offline’ on data which has been measured and recorded previously. Alternatively it may be performed in ‘real-time’, that is, substantially at the same time that the data is measured. In this case, the safe zone determining module 36 may be coupled to the gas turbine engine 10 and may be coupled with the control system 30 or another on-board processor. Where the gas turbine engine 10 powers an aircraft, the safe zone determining module 36 may be coupled with the control system 30, a processor on-board the gas turbine engine 10, or a processor on-board the aircraft.

Additionally, the controller 38 may comprise any suitable circuitry to cause performance of the methods described herein. The control system 30 may comprise: control circuitry; and/or processor circuitry; and/or at least one ASIC; and/or at least one FPGA; and/or single or multi-processor architectures; and/or sequential/parallel architectures; and/or at least one PLC; and/or at least one microprocessor; and/or at least one microcontroller; and/or a CPU; and/or a GPU, to perform the steps described herein.

In various examples, the controller 38 may comprise at least one processor. Additionally or alternatively, the controller 38 may comprise at least one memory (not shown). The memory may store a computer program comprising computer readable instructions that, when read by the processor, causes performance of the steps described herein. The computer program may be software or firmware, or may be a combination of software and firmware.

In either or both of the aforementioned cases, the processor may be located on the gas turbine engine 10, or may be located remote from the gas turbine engine 10, or may be distributed between the gas turbine engine 10 and a location remote from the gas turbine engine 10. The processor may include at least one microprocessor and may comprise a single core processor, may comprise multiple processor cores (such as a dual core processor or a quad core processor), or may comprise a plurality of processors (at least one of which may comprise multiple processor cores).

In either or both of the aforementioned cases, the memory may be located on the gas turbine engine, or may be located remote from the gas turbine engine, or may be distributed between the gas turbine engine and a location remote from the gas turbine engine. The memory may be any suitable non-transitory computer readable storage medium, data storage device or devices, and may comprise a hard disk and/or solid state memory (such as flash memory). The memory may be permanent non-removable memory, or may be removable memory (such as a universal serial bus (USB) flash drive or a secure digital card). The memory may include: local memory employed during actual execution of the computer program; bulk storage; and cache memories which provide temporary storage of at least some computer readable or computer usable program code to reduce the number of times code may be retrieved from bulk storage during execution of the code.

In either or both of the aforementioned cases, the computer program may be stored on a non-transitory computer readable storage medium. The computer program may be transferred from the non-transitory computer readable storage medium to the memory. The non-transitory computer readable storage medium may be, for example, a USB flash drive, a secure digital (SD) card, an optical disc (such as a compact disc (CD), a digital versatile disc (DVD) or a Blu-ray disc). In some examples, the computer program may be transferred to the memory via a wireless signal or via a wired signal.

Referring again to FIG. 2, the system further comprises an inlet pressure sensor 40, an inlet temperature sensor 42 and a core pressure sensor 44. The inlet pressure sensor 40 and inlet temperature sensor 42 are located in the region of the air intake 12 of the engine 10 and are arranged to measure the stagnation pressure P_{I} and stagnation temperature T_{I} respectively at the air intake 12 of the engine 10. The core pressure sensor 44 is located in the region of the inlet to the high pressure compressor 15 and is arranged to measure the static pressure P_{C} in the region of the inlet to the high pressure compressor 15. The sensors 40, 42, 44 are arranged to generate an inlet pressure parameter, an inlet temperature parameter and a core pressure parameter relating to the pressure/temperature at the respective positions. The value of the parameter generated is related to the respective pressure/temperature and as such the value of the pressure/temperature can be derived from the value of the parameter.

The icing risk determining module 32 is arranged to determine whether there is a risk of engine icing based on certain conditions being met. The system is arranged such that if the conditions are met, a risk of icing is determined and at least one operational parameter of the engine 10 (e.g. idle speed, compressor bleed) is controlled to mitigate the risk of icing. In this arrangement, the icing risk determining module 32 is connected to the inlet temperature sensor 42 and the main engine control system (not shown) is arranged to determine that there is a risk of icing when the inlet temperature is within a predetermined range and when the aircraft is in descent.

The calculation module 34 is arranged to calculate the core temperature T_{C} in the region of the inlet to the high pressure compressor 15. In this arrangement the calculation module 34 is connected to the inlet pressure sensor 40, the inlet temperature sensor 42 and the core pressure sensor 44. The calculation module 34 is arranged to calculate a core temperature parameter based on the inlet pressure parameter, the inlet temperature parameter and the core pressure parameter. The core temperature parameter relates to the core temperature in the region of the inlet to the high pressure compressor 15. The calculation module 34 may be arranged to calculate the actual value of the core temperature T_{C} (for example in ° C.) or a core temperature parameter relating to the core temperature. Similarly, the calculation module 34 may also be arranged to convert the inlet pressure parameter, the inlet temperature parameter and the core pressure parameter into the actual values (for example in psia or ° C.).

The safe zone determining module 36 is arranged to determine whether the engine 10 is operating within a safe zone. The safe zone determining module 36 is arranged to receive the core temperature T_{C} and the core pressure P_{C} from the calculation module 34. In this arrangement the safe zone determining module 36 is arranged to receive the absolute values in ° C. and psia, although in other arrangements it could be arranged to receive a core temperature parameter representing the core temperature and a core pressure parameter relating to the core pressure. The safe zone determining module is arranged to calculate a product X_{C} of the core pressure P_{C} and core temperature T_{C}. This product X_{C} is then compared to a safe threshold. Based on this comparison, the safe zone determining module 36 is arranged to determine whether the engine 10 is operating within the safe zone. The controller 38 is arranged to control at least one operational parameter of the engine 10, such as the idle speed, in order to ensure that the engine 10 is operating within the safe zone.

In use, the icing risk determining module 32 continually monitors whether there is a risk of icing. As described above, in this arrangement it is determined that there is a risk of icing when it is determined that the aircraft is in descent and when it is determined that the ambient air temperature (measured using the temperature sensor 42) is between 6 and 20 degrees centigrade above the international standard atmosphere (ISA) at any given altitude. If both of these conditions are met, then the icing risk determining module 32 will determine that there is a risk of icing. In response to determining that there is a risk of icing the controller 38 will control an operational parameter of the engine 10, thus preventing the formation of ice.

In this arrangement, the controller 38 controls an operational parameter of the engine 10 so that it operates within a “safe zone” in which ice will not form within the engine. The “safe zone” is defined by the product of the core pressure P_{C} and the core temperature T_{C} being above a safe threshold. With the core pressure P_{C} being measured in psia, and the core temperature T_{C} being measured in degrees centigrade, in this arrangement the safe threshold is 160. This safe threshold is defined by the fact that ice crystal formation can occur within the engine when the wet bulb temperature within the engine is below freezing and the dry bulb temperature is above freezing. In such a situation, partially melted ice crystals may freeze onto cold surfaces within the engine and can build up, potentially resulting in engine instability and/or engine damage. However, if the air temperature is high enough such that both the wet bulb temperature and the dry bulb temperature are above freezing, then no ice build-up can occur. The safe threshold of 160 is therefore the threshold over which it is known that the conditions will not allow ice formation within the engine. This can be approximately modelled by the relationship pressure (psia)× temperature (° C.)>160.

The calculation module 34 receives the inlet pressure parameter relating to the inlet pressure P_{I}, the inlet temperature parameter relating to the inlet temperature T_{I} and the core pressure parameter relating to the core pressure P_{C}. Using the values of these parameters the calculation module 34 calculates the core temperature T_{C} in degrees centigrade. In this arrangement the calculation module 34 converts the values of the parameters output by the sensors into psia and degrees centigrade, and calculates the core temperature in degrees centigrade, but it should be appreciated that in other arrangements the temperatures/pressures could be output in other units of measurement.

The safe zone determining module 36 receives the core pressure P_{C} (in psia measured using the pressure sensor 44) and the core temperature T_{C} (in degrees centigrade and calculated by the calculation module 34) and calculates the product X_{C} of the core pressure P_{C} and core temperature T_{C}. The product is then compared to a predetermined safe threshold which in this arrangement is 160. If the product X_{C} is less than or equal to the predetermined safe threshold of 160 then the safe zone determining module 36 determines that the engine 10 is not operating in the safe zone. If the product X_{C} is larger than the predetermined safe threshold of 160 then the safe zone determining module 36 determines that the engine 10 is operating within the safe zone. It should be appreciated that if other units were used then the safe threshold would have a different value.

Further, there may be other ways of determining that the engine is operating within a “safe zone” based on a core pressure parameter and a core temperature parameter. For example, the safe zone determining module 36 may determine a dynamic safe temperature threshold based on the current core pressure P_{C} and the relationship between the core pressure, core temperature and predetermined safe threshold. This safe temperature threshold may indicate the temperature above which the engine 10 is operating within the safe zone.

If the safe zone determining module 36 determines that the engine 10 is not operating within the safe zone (i.e. the product X_{C} is 160 or less) then the controller 38 controls an operational parameter of the engine 10 so that the engine 10 does operate within the safe zone. In this arrangement, if the product X_{C} is 160 or less then the controller 38 increases the idle speed of the engine 10. This will increase the core pressure P_{C} and the core temperature T_{C} of the engine 10 so that the engine 10 operates within the safe zone. There is a feedback loop in that the calculation module 34 continually calculates and provides the core pressure P_{C} and the core temperature T_{C} to the safe zone determining module 36 which continually checks whether the engine 10 is operating in the safe zone. The idle speed of the engine 10 is thus controlled by the controller 38 to ensure that the engine operates in the safe zone.

If the icing risk determining module 32 determines that there is no longer a risk of icing, the safe zone determining module 36 may no longer determine whether or not the engine 10 is operating within a safe zone and the controller 38 may therefore no longer control the idle speed of the engine 10.

The arrangement described above provides a control loop to dynamically adjust the idle speed of the engine to ensure that the engine 10 always operates within a safe zone when there is a risk of icing, thus mitigating the risk of ice formation.

Although it has been described that the controller 38 controls the idle speed of the engine to mitigate the risk of ice formation, in other arrangements other operational parameters could be controlled to prevent the formation of ice. For example, the bleed from the engine compressor could be controlled to keep the engine operating in the safe zone. In another arrangement the controller 38 could control the variable stator vanes and/or the variable guide vanes so as to ensure that the engine 10 operates within a safe zone in which the risk of icing is mitigated.

In the arrangement described above the core temperature parameter is calculated based on a measured core pressure parameter, a measured inlet temperature parameter and a measured inlet pressure parameter. However, it should be appreciated that in other arrangements any of these parameters may be measured or calculated based on other measured parameters. For example, there may be no core pressure sensor 44 and instead the inlet pressure parameter, the inlet temperature parameter and one or more of the fan speed and the intermediate pressure compressor speed may be used to calculate a core pressure parameter and a core temperature parameter. The variable geometry and bleed settings for the IP compressor may be additionally used to calculate the core pressure parameter and the core temperature parameter.

It should be appreciated that there may be no icing risk determining module 32 and instead the control loop to keep the engine 10 operating in the safe zone may always be operating. Alternatively, in other arrangements the icing risk determining module 32 may determine that there is a risk of icing based on any number of suitable conditions, either in isolation or in combination. For example, a temperature sensor may be provided at the region of the inlet to the high pressure compressor 15 which is arranged to generate a core temperature parameter representing the core temperature. This measured core temperature may be compared with a calculated expected core temperature T_{C}, and if the measured temperature is less than the expected temperature T_{C} by a predetermined amount then it may be determined that there is an icing risk.

Some aspects of the above-described apparatus, system and methods, may be embodied as machine readable instructions such as processor control code, for example on a non-volatile carrier medium such as a disk, CD- or DVD-ROM, programmed memory such as read only memory (Firmware), or on a data carrier such as an optical or electrical signal carrier. For some applications, arrangements will be implemented on a DSP (Digital Signal Processor), ASIC or FPGA. Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). The code may be distributed between a plurality of coupled components in communication with one another. Where appropriate, arrangements may also be implemented using code running on a field-(re)programmable analogue array or similar device in order to configure analogue hardware.

It will be understood that the disclosure is not limited to the arrangements above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A system for operating a gas turbine engine to mitigate the risk of ice formation within the gas turbine engine, the system comprising:
a controller configured to control at least one operational parameter of the gas turbine engine such that the gas turbine engine operates in a safe zone; and,
a processor configured to function as a determining module to make a comparison between values and determine whether the gas turbine engine is operating within the safe zone based on at least a core pressure parameter relating to the pressure within the gas turbine engine and a core temperature parameter relating to the temperature within the gas turbine engine,
wherein the safe zone is defined by the product (multiplied) of the core pressure parameter and core temperature parameter being above a safe threshold.

2. A system for operating a gas turbine engine according to claim 1, wherein the core pressure parameter relates to the static pressure within the gas turbine engine.

3. A system for operating a gas turbine engine according to claim 1, wherein the core temperature parameter relates to the stagnation temperature within the gas turbine engine.

4. A system for operating a gas turbine engine according to claim 1, wherein the core pressure parameter is generated using a pressure sensor.

5. A system for operating a gas turbine engine according to claim 1, wherein the core temperature parameter is calculated based on at least the core pressure parameter.

6. A system for operating a gas turbine engine according to claim 1, wherein the core pressure parameter and the core temperature parameter relate to the pressure and temperature respectively in the region of the inlet to the high pressure compressor of the gas turbine engine.

7. A system for operating a gas turbine engine according to claim 1, wherein the core pressure parameter is calculated based on at least an inlet pressure parameter relating to the pressure in the region of the inlet of the gas turbine engine.

8. A system for operating a gas turbine engine according to claim 1, further comprising determining that there is a risk of icing and in response thereto, controlling at least one operational parameter of the gas turbine engine such that the gas turbine engine operates in the safe zone.

9. A system for operating a gas turbine engine according to claim 8, wherein it is determined that there is a risk of icing based on at least it being determined that the aircraft is in descent.

10. A system for operating a gas turbine engine according to claim 8, wherein it is determined that there is a risk of icing based on at least it being determined that the ambient temperature is within a predefined range.

11. A system for operating a gas turbine engine according to claim 8, wherein it is determined that there is a risk of icing based on at least it being determined that a measured temperature parameter relating to a temperature within the gas turbine engine is below a threshold.

12. A system for operating a gas turbine engine according to claim 1, wherein controlling at least one operational parameter comprises controlling the idle speed of the gas turbine engine.

13. A system for operating a gas turbine engine according to claim 1, wherein controlling at least one operational parameter comprises controlling the bleed from the compressor.

14. A system for operating a gas turbine engine according to claim 1, wherein controlling at least one operational parameter comprises controlling the variable inlet guide vanes and/or the variable stator vanes.

15. A method of operating a gas turbine engine of an aircraft to mitigate the risk of ice formation within the gas turbine engine, the method comprising controlling at least one operational parameter of the gas turbine engine such that the gas turbine engine operates in a safe zone, wherein it is determined that the gas turbine engine is operating within a safe zone based on at least a core pressure parameter relating to the pressure within the gas turbine engine and a core temperature parameter relating to the temperature within the gas turbine engine, wherein the safe zone is defined by the product (multiplied) of the core pressure parameter and core temperature parameter being above a safe threshold.
